(19) United States
(12) Patent Application Publication
(10) Pub. No.: US 2003/0211820 A1
(43) Pub. Date: Nov. 13, 2003

(54) Car defroster

(76) Inventors: Yoshinori Tsuji, Kariya-city (JP); Yuichi Kajino, Nagoya-city (JP); Masahiko Sugaya, Anjo-city (JP)

Correspondence Address: HARNESS, DICKEY & PIERCE, P.L.C., P.O. BOX 828, BLOOMFIELD HILLS, MI, 48303, US

(21) Appl. No.: 10/431,260

(22) Filed: May 7, 2003

(30) Foreign Application Priority Data
May 9, 2002 (JP) 2002-134090

(51) Int. Cl. B60S 1/54

(52) U.S. Cl. 454/93

(57) ABSTRACT

In a car defroster which detects the clouding on the window glass by a sensor and blows conditioned air out from the defroster port to the window glass to remove the blur, an infrared sensor 1 is used as the sensor for measuring the surface temperature of the window glass, and the defrosting operation is carried out according to the measuring result. The infrared sensor is provided, for example, at a center of the ceiling of the passenger compartment, and consists of at least two sensor elements so that the temperatures of window glasses in a plurality of directions are detectable.

### BACKGROUND OF THE INVENTION

1. Field of the Invention

The present invention relates to a defroster for a window glass of a car and is particularly applicable to a car provided with an automatic air-conditioner having a temperature sensor.

2. Description of the Related Art

Generally speaking, as an air temperature lowers, it is difficult to see through car window glass due to dew condensation on the inner surface. To solve this problem, particularly in a front window glass, a defroster is provided and manually controlled as necessary.

However, the provision of a car air-conditioner has recently become popular. Accompanied therewith, an automatically operable defroster has been used in a car.

In this regard, in a conventional defroster, as disclosed in Japanese Unexamined Patent Publication (Kokai) Nos. 63-90424 or 7-172140, a window temperature is estimated from an outdoor air temperature, an air temperature in the passenger compartment, a blowout air temperature, solar radiation, a vehicle speed, a thermal conduction coefficient of glass or others so that the defrosting operation is enhanced. That is, as shown in FIG. 6, the estimated window temperature is calculated from five elements; a vehicle speed, a solar radiation, outdoor air temperature, a passenger compartment temperature and humidity; as detected by the respective sensors, and the defrosting operation is carried out so that the glass surface temperature does not reach the dew point.

However, when this method is put into practice, it is necessary to estimate the glass temperature as somewhat lower than the actual temperature so that the clouding of the window glass is assuredly prevented from occurring. As a result, the number of useless defrosting operations increase to worsen the fuel consumption rate and deteriorate the comfort in the passenger compartment.

Also, in the prior art, it is impossible to detect a change in glass temperature not caused by the above-mentioned five elements, such as rain or snow. In such a case, there is a drawback in that the adjustment must rely on a manual operation by the driver. To solve this drawback, the direct measurement of the glass temperature is effective. However, even if the measurement is carried out by using a thermocouple or the like, the measurable range is limited to the vicinity of the measuring device and it is difficult to detect the actual state of a large area of glass.

### SUMMARY OF THE INVENTION

The present invention has been made to solve the above problems, and an object thereof is to provide a car defroster capable of carrying out the defrosting operation in a required portion at a time actually requiring the same to save energy by eliminating useless defrosting operations and improve the comfort of the passenger compartment. This defroster is also capable of individually carrying out a defrosting operation on all of the window glasses.

A car defroster according to one aspect of the present invention uses an infrared sensor as a sensor for detecting a clouding such as a frost or a fog on a window glass, capable of measuring a surface temperature of the window glass. Thus, the surface temperature of the window glass can be accurately measured and not estimated as in the prior art. Thereby, it is possible to assuredly carry out the effective defrosting operation while avoiding useless operations.

In the car defroster according to the present invention, the infrared sensor may be provided approximately in a central area of the passenger compartment. Thereby, the temperatures of all the window glasses are individually detectable.

In the car defroster according to the present invention, the infrared sensor may be provided in a ceiling of the passenger compartment. Thereby, the temperatures of the window glasses in all directions are detectable without being disturbed by obstacles. Also, even if the sensor has a narrow view angle, it is possible to ensure the minimum detection range.

In the car defroster according to the present invention, the infrared sensor may be integral with a functional module provided in a central area of the front ceiling of the passenger compartment. Thereby, the number of parts can be reduced.

In the car defroster according to the present invention, the infrared sensor may be integral with a functional module provided in the central ceiling of the passenger compartment. Thereby, the number of parts can be reduced.

In the car defroster according to the present invention, the infrared sensor may detecte the temperatures of the window glasses at least in two directions. Thereby, it is possible to measure the temperature of the window glass in a plurality of directions.

In the car defroster according to the present invention, the infrared sensor may be provided in a rotatable manner to detect the temperatures of the window glasses in all directions.

In the car defroster according to the present invention, the infrared sensor detects the temperature of the window glass provided in the respective direction, which results are connected with independent air-conditioning systems. Thereby, it is possible to individually carry out the defrosting operation to the respective window glass.

In the car defroster according to the present invention, the infrared sensor is a multi-divided infrared sensor capable of detecting multi-divided areas, whereby it is possible to measure the temperature distribution on the surface of the window glass and carry out a high grade defrosting operation.

In the car defroster according to the present invention, the multi-divided infrared sensor capable of detecting multi-divided areas has a wide angle detection range, whereby it is possible to detect the temperatures of a plurality of window glasses by a single sensor.

In the car defroster according to the present invention, the infrared sensor may be adapted to measure the temperature of the front window glass within a field of view of a driver, whereby it is possible to actually carry out the defrosting operation in a necessary portion at a necessary time.

In the car defroster according to the present invention, the infrared sensor may be adapted to measure the temperature of the window glass within the passenger compartment in the vicinity of a side mirror, whereby it is possible to ensure the visibility of the side mirror to further enhance safety.

According to another aspect of the present invention, the car defroster comprises a controller, a defrosting apparatus blowing hot air or dry air to the window glass, and a humidty sensor provided in a passenger compartment, wherein the controller comprises means S1 for detecting the temperature of the window glass by a signal from an infrared sensor 1 and detecting the humidity in the passenger compartment by a signal from the humidity sensor, determination means S2 for calculating a dew point on the glass surface by the temperature of the window glass detected by the infrared sensor 1 and the humidity in the passenger compartment detected by the humidity sensor, comparing the calculated dew point with the window glass temperature and determining the clouding state in accordance with the comparison result, and means S3 for starting the defrosting operation in accordance with the determination of the determination means S3.

According to a further aspect of the present invention, the car defroster comprises a controller, an apparatus operable when the car air-conditioner is in the defrosting mode and a humidity sensor provided in a passenger compartment, wherein the controller comprises means S1 for detecting the temperature of the window glass by a signal from an infrared sensor 1 and detecting the humidity in the passenger compartment by a signal from the humidity sensor, determination means S2 for calculating a dew point on the glass surface by the temperature of the window glass detected by the infrared sensor 1 and the humidity in the passenger compartment detected by the humidity sensor, comparing the calculated dew point with the window glass temperature and determining whether there is a clouding or not in accordance with the comparison result, and means S3 for making the car air-conditioner to the defrosting mode and starting the defrosting operation when there is the blur.

The present invention may be more fully understood from the description of the preferred embodiments of the invention, as set forth below, together with the accompanying drawings.

### BRIEF DESCRIPTION OF THE DRAWINGS

In the drawings;

FIG. 1 is a schematic side view explaining a position of an infrared sensor in a car defroster according to one embodiment of the present invention;

FIG. 2 is a plan view thereof;

FIG. 3 is a flow chart for explaining the operation of the car defroster according to the embodiment of the present invention;

FIG. 4 schematically illustrates a multi-divided infrared sensor according to another embodiment of the present invention;

FIG. 5 schematically illustrates an infrared sensor integral with a map lamp according to a further embodiment of the present invention; and

FIG. 6 schematically illustrates a concept of the defrosting control in the conventional defroster.

### DESCRIPTION OF THE PREFERRED EMBODIMENTS

A car defroster according to the present invention will be described below with reference to the drawings. In this regard, the car defroster referred to in the present invention is one capable of operating a car air-conditioner in a defrosting mode, and therefore, it has the same meaning as a car air-conditioner.

In general, a car air-conditioner is provided with a heater core for a heater unit and an evaporator for a cooling unit, wherein air passing through the evaporator is divided into an amount of air entering the heater core and an amount of air not entering the heater core by an air mixing door and mixing the both to regulate the temperature after the heater core, which conditioned air is blown into the passenger compartment.

That is, air sucked from an outer air suction port and an inner air suction port are blown by a blower fan and first subjected to the heat-exchange in the evaporator to be cold air. Downstream of the evaporator, a flow path of the conditioned air is bifurcated. One flow path passes through the heater core and air passing through this flow path is subjected to heat-exchange, at the heater core, to become hot air; the other flow path bypasses the heater core and air passing through this flow path remains cold. At the dividing point of these two flow paths, an air mixing door is provided and, by controlling the degree of opening of the air mixing door, a ratio of the amounts of air passing through the flow paths is regulated.

The conditioned air, of which the temperature is adjusted by the air mixing door, is blown into the passenger compartment from a face blow out port, a foot blow out port, a defroster blow out port or others. At these ports, doors are provided, respectively, so that the blow out direction of the conditioned air is selected. For example, in the defroster, the blowoff port is branched to those for a front defroster, a side defroster and rear defroster. In the defrosting mode, clouding on the respective window glasses are removed by the blow out of the conditioned air from the respective defroster ports.

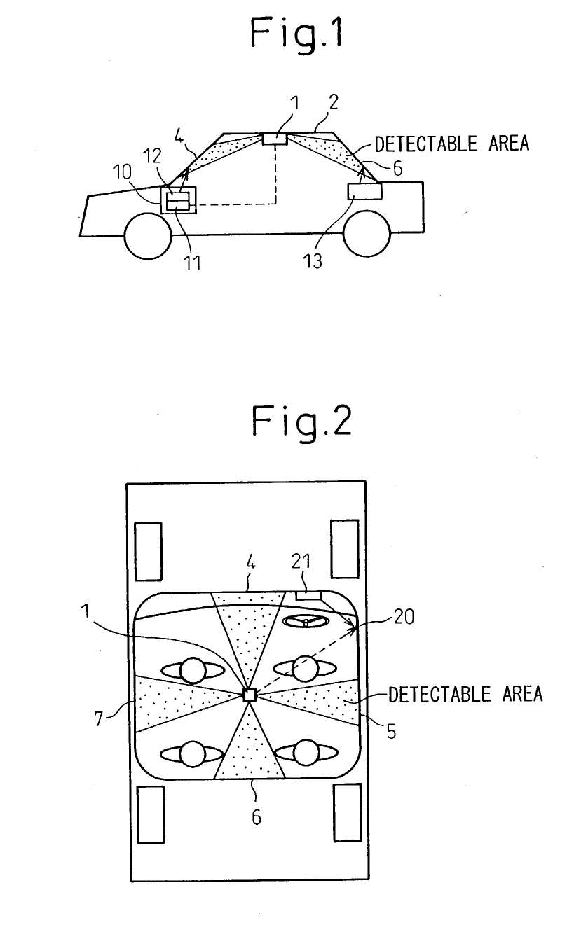

FIGS. 1 and 2 schematically explain the operation of an infrared (IR) sensor 1 used in one embodiment of the car defroster. In FIG. 1, to detect a clouding state on a car window glass, a infrared sensor 1 is provided on a ceiling 2 at a position in the vicinity of a center of the passenger compartment, for detecting the surface temperature of the window glass. This infrared sensor 1 consists of four infrared sensor elements so that the temperature of each of four side window glasses is detectable as shown in FIG. 2. By providing the infrared sensor 1 on the ceiling 2 at a position in the vicinity of a center of the passenger compartment, it is possible to detect the temperature of the window glasses in all the directions while avoiding the effect of obstacles. By providing the infrared sensor at a distance from the window glass, it is possible to ensure the minimum detectable range even if the sensor is that having a narrow angle of visual field. Also, as no direct sunlight is incident upon the sensor itself, the sensor is hardly effected by solar radiation. In FIG. 1, reference numeral 10 denotes a front side car air-conditioner, 11 denotes a controller having a computer therein provided within the car air-conditioner, 12 denotes a front defroster and 13 denotes a rear defroster.

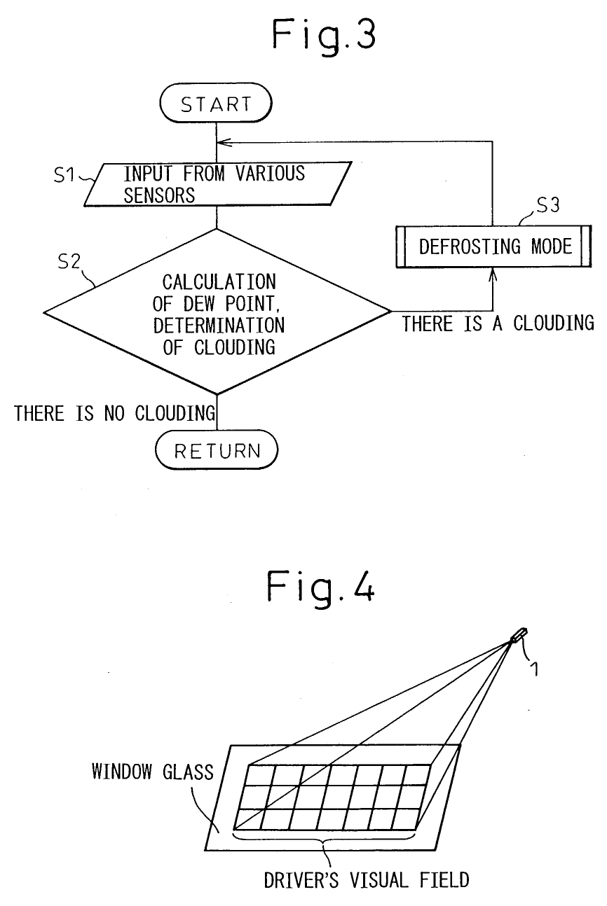

Next, the operation of the defroster according to the present invention will be described with reference to a flow chart in FIG. 3. This flow chart is related to the computer within the controller 11 shown in FIG. 1. At step S1, the window glass temperature is detected by the infrared sensor 1 and the humidity in the passenger compartment is detected by a humidity sensor not shown provided in the passenger compartment. Then, at step S2, a dew point of the glass surface is calculated from the window glass temperature and the passenger compartment humidity detected at step S1. The dew point is compared with the window glass temperature.

In this regard, the clouding on the inner surface of the window glass is generated due to the condensation of the moisture in the air on the inner surface of the window glass when the dew point in the vicinity of the inner surface of the window glass is higher than the inner surface temperature of the window glass. Therefore, to prevent the generation of blur, either the dew point may be lowered in the vicinity of the inner surface of the window glass by the removal of air moisture, or the inner surface temperature of the window glass may be made to rise by the heating.

Accordingly, when the dew point is lower than the window glass temperature at step S2, it is determined that there is no blur on the window glass, and the control, that is, the defrosting operation, is not carried out.

If the dew point is equal to or higher than the window glass temperature, even though the car air-conditioner is operating in the automatic air-conditioning (auto-A/C) mode, the car air-conditioner is switched to the defrosting (F/D) mode at step S3 in which the door of the predetermined defroster is opened to start the defrosting operation by blowing hot air or dry air onto the window glass as shown by arrows in FIG. 1, that is, the conditioned air is blown out from the defroster to the window glass. This operation continues until the window glass temperature becomes higher than the dew point plus 3° C. In this regard, the evaporator temperature or an amount of air blown out from the blower is controlled in a stepwise manner in accordance with the degree of clouding generated (the difference between the dew point and the glass window temperature).

According to the present invention, it is possible to carry out the defrosting operation when it is actually necessary as the window glass temperature is accurately detected as a measured value and not as an estimated value as in the prior art. Thus, the saving of power and an improvement in comfort in the passenger compartment are simultaneously achievable. Also, it is possible to deal with causes which could not be solved by the prior art, such as rain or snow.

While the infrared sensor 1 is provided on a ceiling at a position in the vicinity of a center of the passenger compartment in the above embodiment shown in FIGS. 1 and 2, it may be provided at other positions such as a center of the passenger compartment or a ceiling of the front passenger compartment.

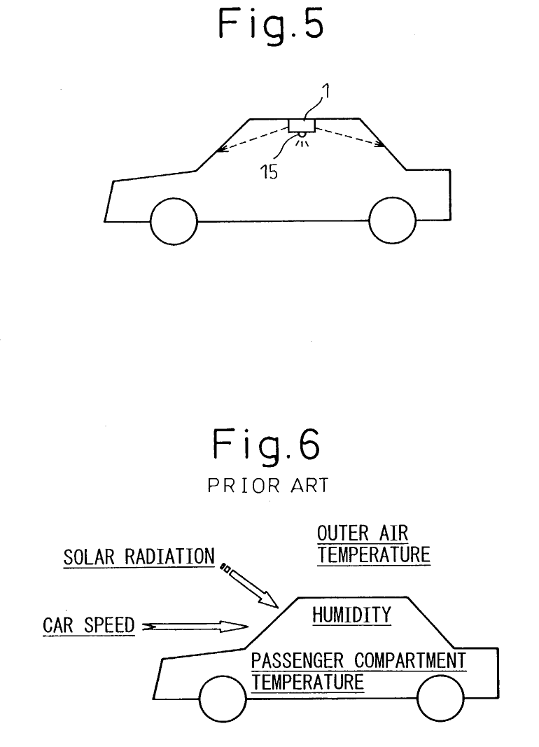

The infrared sensor 1 may be provided integral with a functional module at a position on a front passenger compartment ceiling, such as a room mirror, a map lamp or a keyless receiver or with a functional module at a position on a central passenger compartment ceiling, such as a room lamp or a sensor detecting a smoke of a cigarette. Thereby, it is possible to simplify the appearance and reduce the number of parts. In another embodiment shown in FIG. 5, the infrared sensor 1 is integral with a map lamp 15 which is manually lit when viewing a map in the passenger compartment.

Further, while four infrared sensor elements 1 are provided in four directions to detect the temperature of each of front, rear and lateral side window glasses in FIG. 2, two infrared sensor elements may be provided in the front and rear direction to solely detect the temperature of each of front and rear window glasses. The number of infrared sensor elements may be increased to detect the temperature of window glasses positioned in other than the front, rear and both side directions.

The well-known rotary drive device (not shown) may be provided at the attachment portion of the infrared sensor 1 to rotate the infrared sensor itself and detect the temperature of the window glasses in all the directions. In this case, the temperature of the window glass in an optional direction can be detected by a single infrared sensor 1 to reduce the number of leads connected to the sensor. In this case, with reference to FIG. 2, it is possible to detect the temperature of the window glass 20 in the passenger compartment in the vicinity of a side mirror and to carry out the defrosting operation so that the visibility of the side mirror is ensured by the defroster 21.

While a common air-conditioning system is used for the defrosting control of the respective window glasses in the above embodiment, individual air-conditioning systems may be combined with the respective window glasses to carry out the optimum defrosting operation therefor. That is, in FIG. 1, the rear defroster may not be provided, and if any one of window glasses 4, 6 is blurred, the front defroster is solely operated. However, if the rear defroster is provided, the defrosting operation for the rear window glass 6 may be optimally carried out by the rear defroster 13.

As shown in FIG. 4, a multi-divided infrared (IR) sensor capable of detecting the distribution of the window glass temperature may be provided as the infrared sensor 1. By using the same, a high-grade defrosting control becomes possible, for solely aiming to a small area in which the clouding is generated. That is, the usual infrared sensor 1 can recognize a visual field as a single area. Contrarily, the multi-divided infrared sensor divides the visual field, for example, into 3×7=21 areas as shown in FIG. 4 and is capable of detecting the temperature of the respective areas, whereby it is possible to determine which area of the window glass may generate clouding and to take a suitable countermeasure. A multi-divided infrared sensor of a wide angle type may be used. In this case, it is possible to detect the temperature of a plurality of window glasses by a single sensor.

In this connection, the car defroster described in this specification adopts an automatic air-conditioner capable of detecting the temperature change inside and outside of the passenger compartment and automatically regulating the temperature within the compartment and an amount of conditioned air to maintain the set temperature. In this case, other than the control of the compartment temperature and the amount of air, the control of the compressor (ON-OFF of the compressor), the control of suction port (switching of inner and outer air) and the control of blowoff port (switching of blowoff mode) are carried out by microcomputer control.

What is claimed is:

1. A car defroster for detecting the clouding on a window glass of a car by a sensor and removing the clouding on the window glass by blowing out the conditioned air from a defroster port provided in the vicinity of the window glass, wherein
the sensor is an infrared sensor for measuring the surface temperature of the window glass.

2. A car defroster as defined by claim 1, wherein the infrared sensor is provided approximately at a center of a passenger compartment.

3. A car defroster as defined by claim 1, wherein the infrared sensor is provided on a ceiling of the passenger compartment.

4. A car defroster as defined by claim 1, wherein the infrared sensor is integral with a functional module provided at a center of the front ceiling of the passenger compartment.

5. A car defroster as defined by claim 1 or 3, wherein the infrared sensor is integral with a functional module provided in the central ceiling of the passenger compartment.

6. A car defroster as defined by claim 1, wherein the infrared sensor is provided to be directed in at least in two directions.

7. A car defroster as defined by claim 1, wherein the infrared sensor is provided in a rotatable manner so that the temperature of the window glasses, in all directions, is detectable.

8. A car defroster as defined by claim 1, wherein the infrared sensor detects the temperature of the window glasses in the respective directions, which temperature is connected with the respective independent air-conditioning system to carry out the individual defrosting operation for the respective window glass.

9. A car defroster as defined by claim 1, wherein the infrared sensor is a multi-divided infrared sensor capable of measuring the surface temperature distribution of the window glass.

10. A car defroster as defined by claim 9, wherein the multi-divided infrared sensor has a wide-angle detection area so that the temperatures of a plurality of window glasses are detectable.

11. A car defroster as defined by claim 1, wherein the infrared sensor measures the window glass temperature within a visual field of the operator on the front window glass.

12. A car defroster as defined by claim 1, wherein the infrared sensor measures the temperature of the window glass, in the passenger compartment, in the vicinity of a side mirror to carry out the defrosting operation so that the visibility of the side mirror is ensured.

13. A car defroster, comprising a controller, a defrosting apparatus blowing hot air or dry air to the window glass and a humidty sensor provided in a passenger compartment, wherein the controller comprises
means S1 for detecting the temperature of the window glass by a signal from an infrared sensor 1 and detecting the humidity in the passenger compartment by a signal from the humidity sensor,
determination means S2 for calculating a dew point on the glass surface from the temperature of the window glass detected by the infrared sensor 1 and the humidity in the passenger compartment detected by the humidity sensor, comparing the calculated dew point with the window glass temperature and determining the clouding state in accordance with the comparison result, and
means S3 for starting the defrosting operation in accordance with the determination of the determination means S2.

14. A car defroster, comprising a controller, an apparatus operable when the car air-conditioner is in the defrosting mode and a humidity sensor provided in a passenger compartment, wherein the controller comprises
means S1 for detecting the temperature of the window glass from a signal from an infrared sensor 1 and detecting the humidity in the passenger compartment by a signal from the humidity sensor,
determination means S2 for calculating a dew point on the glass surface from the temperature of the window glass detected by the infrared sensor 1 and the humidity in the passenger compartment detected by the humidity sensor, comparing the calculated dew point with the window glass temperature and determining whether there is a clouding or not in accordance with the comparison result, and
means S3 for setting the car air-conditioner in the defrosting mode, and starting the defrosting operation, when there is the blur.
